(19) United States
(12) Patent Application Publication
(10) Pub. No.: US 2003/0018798 A1
(43) Pub. Date: Jan. 23, 2003

(54) Multimedia contents description model

(75) Inventors: Jae-Hyuck Lee, Seoul (KR); Young-Won Song, Seoul (KR)

Correspondence Address: FLESHNER & KIM, LLP, P.O. Box 221200, Chantilly, VA, 20153-1200, US

(73) Assignee: LG Electronics Inc.

(21) Appl. No.: 10/197,867

(22) Filed: Jul. 19, 2002

(30) Foreign Application Priority Data
Jul. 20, 2001 (KR) 43822/2001

(51) Int. Cl. G06F 15/16

(52) U.S. Cl. 709/231

(57) ABSTRACT

A method of performing a multimedia contents description according to the present invention is comprised of: incorporating information on a Description Scheme Binding for supporting connection with and use of at least one multimedia contents description scheme; incorporating information on a MPEG-21 Interface for supporting intellectual property management & protection of multimedia contents, treatment and use of multimedia contents, a protocol and an interface which are related to a network and a terminal through which multimedia contents are transmitted, and an event reporting on multimedia contents; and incorporating a Description Management for providing a mechanism to support operation and management for production, modification, access and use of metadata which are described according to a multimedia contents description scheme.

A multimedia contents description model according to the present invention has an advantage of making comprehensive use of a standard multimedia contents description scheme that exists or could be developed in the future.

### BACKGROUND OF THE INVENTION

1. Field of the Invention

The present invention relates to a multimedia contents description model for easy and efficient use of multimedia contents in activities such as production, process, transaction, delivery, management, storage, consumption of multimedia contents under wired and wireless circumstances. More specifically, the present invention relates to a multimedia contents description model, which is compatible with a core technology relating to the business model in electronic commerce, which accepts and utilizes an existing multimedia contents description model, which provides a mechanism for efficient management of the contents description itself.

2. Description of the Related Art

With the development of an Internet, variety of standard technologies for a series of activities ranging from production through consumption of multimedia contents have been developed and such technologies are also under development in various ways. One of the important technologies among those technologies is a multimedia contents description model.

For the conventional multimedia contents description model, MPEG-7 MDS (Multimedia Description Scheme), ONIX (Online Information exchange), etc. have been developed or being developed. But such models are limited to specific type or format of multimedia contents. For example, MPEG-7 MDS was designed for multimedia contents such as audio, video, and ONIX was designed for electronic book. Therefore, a widely accepted modeling is required to accommodate standard multimedia contents descriptions of various multimedia contents types or formats.

Furthermore, existing multimedia contents description models have some problems in that those models have been designed without sufficient consideration of business models in electronic commerce. Therefore, an interoperable and compatible multimedia contents description model is required to consider various business models in electronic commerce.

More specifically, existing multimedia contents description models, for example, do not provide a comprehensive description model for intellectual property management and protection of multimedia contents, treatment and use of multimedia contents, a protocol and an interface relating to a network and a terminal through which multimedia contents are transmitted, and reporting information of all activities relating to multimedia contents. Only a limited description model has been designed to cover some part of that information.

Also, under the trend which scale of electronic commerce is gradually increasing due to the development of an Internet, the structure of description data, also called as metadata relating to multimedia contents information is getting complicated more and more due to various types of multimedia formats and usage forms. Accordingly, in designing the mechanism for operation and management of the metadata, an appropriate modeling for a multimedia contents description model is required.

### SUMMARY OF THE INVENTION

Accordingly, the present invention is directed to a multimedia contents description model that substantially obviates one or more of the problems due to limitations and disadvantages of the related art.

It is an object of the present invention to provide an interoperable method of describing multimedia contents, which can be commonly applied in various types of multimedia contents formats.

It is another object of the present invention to provide a comprehensive method of describing multimedia contents for providing information on intellectual property management and protection of multimedia contents, treatment and use of multimedia contents, a protocol and an interface relating to a network and a terminal through which multimedia contents are transmitted, and a report about all activities relating to multimedia contents.

It is still another object of the present invention to provide a mechanism for operation and management for production, modification, access and use of metadata, such that the metadata described according to specific multimedia contents description scheme can be consistently and reliably maintained.

Additional features and advantages of the invention will be set forth in the description that follows, and in part will be apparent from the description, or may be learned by practice of the invention. The objectives and other advantages of the invention will be realized and attained by the structure particularly pointed out in the written description and claims hereof as well as the appended drawings.

To achieve the above object, there is provided a method of performing multimedia contents description according to the present invention, comprising: incorporating information on a description scheme binding for supporting connection with and use of at least one multimedia contents description scheme; incorporating information on a MPEG-21 interface for supporting intellectual property management and protection of multimedia contents, treatment and use of multimedia contents, a protocol and an interface relating to a network and a terminal through which multimedia contents are transmitted, and an event reporting on multimedia contents; and incorporating information on a description management for providing a mechanism to support operation and management for production, modification, access and use of metadata which are described according to multimedia contents description scheme.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the present invention and are incorporated in and constitute a part of this specification, illustrate preferred embodiments of the present invention and together with the description serve to explain the principles of the invention.

In the drawings:

FIG. 1 illustrates a multimedia contents description model according to the present invention;

FIG. 2 illustrates elements of a description scheme binding of a multimedia contents description model according to the present invention;

FIG. 3 illustrates elements of a MPEG-21 defined by a multimedia contents description model according to the present invention; and

FIG. 4 illustrates elements of a description management defined by a multimedia contents description model according to the present invention.

### DETAILED DESCRIPTION OF THE PREFERRED EMBODIMENT

A preferred embodiment of the present invention will be described herein below with reference to the accompanying drawings, which are represented with use of XMLSpy notation.

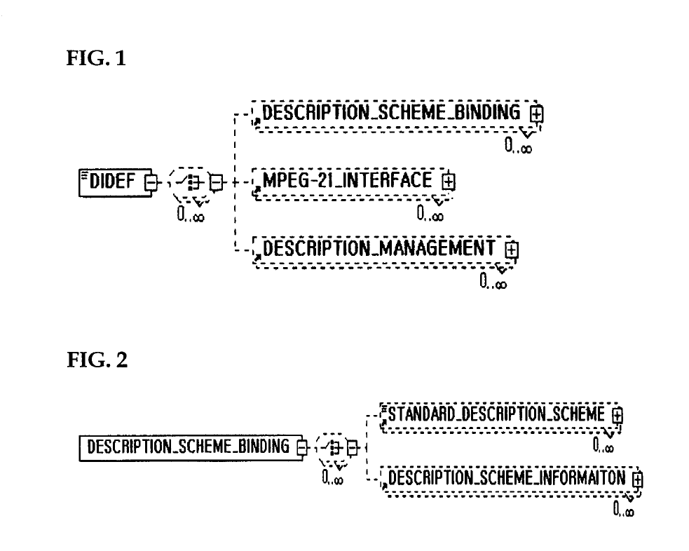

As shown in FIG. 1, the present invention relates to a multimedia contents description model comprising three sub elements denoted by a DESCRIPTION_SCHEME_BINDING, an MPEG-21_INTERFACE, and a DESCRIPTION_MANAGEMENT with root element denoted by DIDEF (Digital Item Description Framework).

As shown in FIG. 2, among three elements of the DIDEF, the DESCRIPTION_SCHEME_BINDING can connect and use an existing multimedia contents description model. To realize above described function, the DESCRIPTION_SCHEME_BINDING according to the invention is comprised of two sub elements, denoted by a STANDARD_DESCRIPTION_SCHEME and a DESCRIPTION_SCHEME_INFORMATION.

Here, out of the two sub elements forming the DESCRIPTION_SCHEME_BINDING, the STANDARD_DESCRIPTION_SCHEME provides a mechanism for connecting an existing standard multimedia contents description model. For example, in case of embodiment using XML Schema Definition Language suggested by W3C (World Wide Web Consortium), a position information of a desired multimedia contents description model is inserted in the XML Schema Namespace, so that description elements of the specific description model can be implemented as sub elements under the STANDATD_DESCRIPTION_SCHEME.

Also, among two sub elements constructing the DESCRIPTION_SCHEME_BINDING, the DESCRIPTION_SCHEME_INFORMATION supports the STANDARD_DESCRIPTION_SCHEME to play a role of providing primary information about an existing standard multimedia contents description model. For more detailed examples, these primary information includes a name of a connected description model, additional information on the multimedia contents description model including a name and an address of an organization or a company that designed and distributed the model, or information about whether a model to be connected is a part of the existing description model or its entirety, or a combination of plurality of description models.

Furthermore, it is also possible to design a model, which provides a SCHEME_SUMMARY element for describing abstract information about a specific description model to be connected. Here, when a user wants to use the primary information, the user can easily apply the information described in accordance with the SCHEME_SUMMARY element.

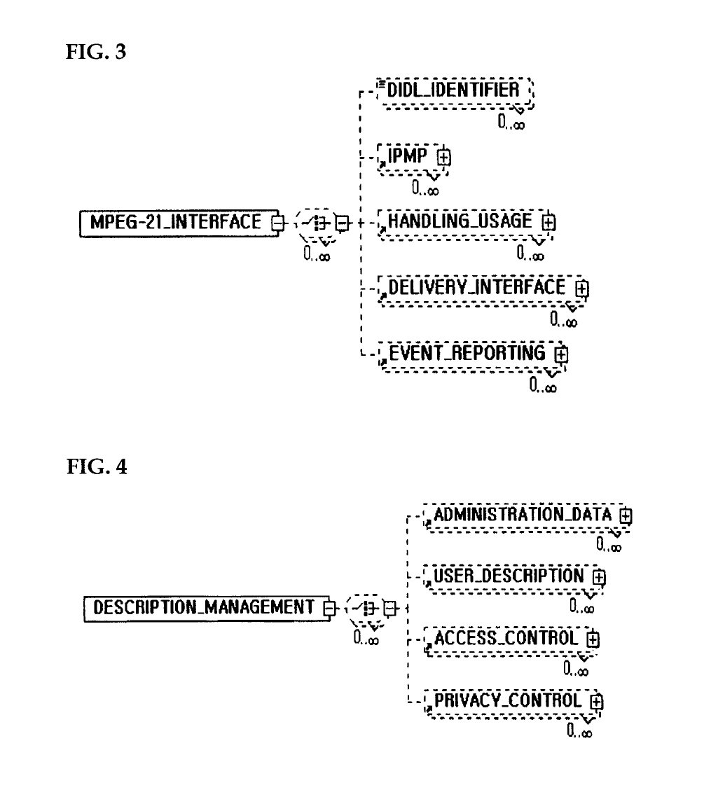

As shown in FIG. 3, in the meantime, the MPEG-21_INTERFACE sub element of the DIDEF is comprised of five sub elements, denoted by a DIDL_IDENTIFIER, an IPMP, a HANDLING_USAGE, a DELIVERY_INTERFACE and an EVENT_REPORTING.

DIDL_IDENTIFIER has position information of multimedia contents that could connect a multimedia contents and its description information, in case that the multimedia contents and its description information are separated and used, respectively.

IPMP (Intellectual Property Management and Protection) plays a role that manages and specific information such as related usage conditions of multimedia contents when transactions regarding supply and usage of multimedia contents are occurred.

HANDLING_USAGE can describe information on production, process, search, access, storage, delivery and use of multimedia contents.

DELIVERY_INTERFACE can describe information that define various protocols and interfaces relating to a network and a terminal through which multimedia contents are transmitted.

EVENT_REPORTING plays a role for modeling information, which is necessary for efficient use of multimedia contents in all activities such as production, transaction, transmission, usage of multimedia contents.

Here, the DIDL_IDENTIFIER sub elements of the MPEG-21_INTERFACE plays a role for providing an interface regarding a multimedia contents identification technology, that one of important fields among various technologies and standard which are under development with respect to transmission and consumption of multimedia contents. For example, if an Identifier to be described by Digital Item Identification, which is under development by ISO/IEC MPEG-21 subcommittee, is provided, such Identifier will be described in the DIDL_IDENTIFIER. Such Identifier can be used in judging on what multimedia contents information is presently being described and in identifying a position of multimedia contents.

Furthermore, the IPMP sub element of the MPEG-21_INTERFACE provides elements for describing information regarding intellectual property management and protection of multimedia contents. Also, the HANDLING_USAGE sub element of the MPEG-21_INTERFACE provides elements for describing information regarding production, process, search, access, storage, delivery and use of multimedia contents. In addition, the DELIVERY_INTERFACE sub element of the MPEG-21_INTERFACE provides elements for describing information about a protocol and interface relating to a network and a terminal through which multimedia contents are transmitted. Furthermore, the EVENT_REPORTING sub element of the MPEG-21_INTERFACE provides elements for describing information about ex post facto report of multimedia contents.

As shown in FIG. 4, among the three sub elements of the DIDEF, the DESCRIPTION_MANAGEMENT provides a mechanism for operation and management regarding production, modification, access and use of metadata which are described in accordance with a multimedia contents description model so that the metadata can be consistently and reliably maintained. For these functions, the DESCRIPTION_MANAGEMENT is comprised of four sub elements denoted by an ADMINISTRATION_DATA, an USER_DESCRIPTION, an ACCESS_CONTROL and a PRIVACY_CONTROL.

Here, among the sub elements of the DESCRIPTION_MANAGEMENT, the ADMINISTRATION_DATA provides information for operation and management regarding production, modification, access and use of metadata of multimedia contents. For example, such information includes version information of metadata, identifier of metadata, production date, modification date, a manager, produced contents, reason of production, etc. As information regarding management of such metadata is described, an organization in charge of metadata management can describe and register reliable information in accordance with a standardized format when producing metadata regarding multimedia contents. Furthermore, it prevents an unauthorized user from arbitrarily modifying the metadata and supports that consistent information regarding multimedia contents can be described based on version and other information of various metadata existing in a network.

Also, among the sub elements of the DESCRIPTION_MANAGEMENT, the USER_DESCRIPTION plays a role for modeling user information including a contents producer, a supplier, a distributor, a right holder and a final consumer existing in business model of electronic commerce. For example, the USER_DESCRIPTION can describe a user identifier, user's role relating to multimedia contents, a name and an address of a user, etc. With the use of such described information, related users involving use and transaction of multimedia contents can be correctly identified. Also, when description of a user is necessary in the sub elements belonging to the DIDEF, more detailed information can be obtained in connection with information described in the USER_DESCRIPTION with limited description of partial information such as a user identifier or a role of the user, etc.

Also, among the sub elements of the DESCRIPTION_MANAGEMENT, the ACCESS_CONTROL plays a role for controlling a user access to metadata of multimedia contents so that only an authorized user can access to it. In order to implement this function, lots of elements are provided, for example, elements subject to the access control, an identification of an authorized user, an access related policy such as an access range, an access period allowed, etc., can be described.

In addition, among the sub elements of the DESCRIPTION_MANAGEMENT, the PRIVACY_CONTROL informs a user of predetermined policy with respect to some contents user wants to protect and provides a privacy control mechanism for a user to judge and describe the contents based on the policy, when producing and modifying the metadata of multimedia contents.

As described above, the multimedia contents description model according to the present invention has an advantage that allows a comprehensive use of standard multimedia contents description model that exists or could be developed in the future.

Furthermore, the present invention is advantageous that it provides a comprehensive multimedia contents description model for describing variety of technologies and functions relating to an electronic commerce business model, i.e., intellectual property management & protection of multimedia contents, treatment and use of multimedia contents, a protocol and an interface relating to a network and a terminal through which multimedia contents are transmitted, and a reporting about all activities relating to multimedia contents.

In addition, the present invention is also advantageous that it further provides a mechanism for operation and management for production, modification, access and use of metadata, such that the metadata described according to specific multimedia contents description scheme can be consistently and reliably maintained.

The foregoing embodiments are merely exemplary and are not to be constructed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method of performing a multimedia contents description, comprising:
incorporating information on a DESCRIPTION_SCHEME_BINDING for supporting connection with and use of at least one multimedia contents description scheme;
incorporating a MPEG-21_INTERFACE for supporting intellectual property management and protection of multimedia contents, treatment and use of multimedia contents, a protocol and an interface relating to a network and a terminal through which multimedia contents are transmitted, and an event reporting on multimedia contents; and
incorporating a DESCRIPTION_MANAGEMENT for providing a mechanism to support operation and management for production, modification, access and use of metadata, which are described according to a multimedia contents description scheme.

2. The method of claim 1, wherein the DESCRIPTION_SCHEME_BINDING includes:
a STANDARD_DESCRIPTION_SCHEME for providing a mechanism to connect an existing multimedia contents description scheme;
a DESCRIPTION_SCHEME_INFORMATION for supporting the STANDARD_DESCRIPTION_SCHEME to provide primary information on the existing standard multimedia contents description scheme.

3. The method of claim 2, wherein the DESCRIPTION_SCHEME_BINDING further includes a SCHEME_SUMMARY for providing abstract information on a specific multimedia contents description scheme to be connected.

4. The method of claim 2, wherein the STANDARD_DESCRIPTION_SCHEME selects a multimedia contents description scheme to be desired and establishes the selected multimedia contents description scheme as a sub element of the STANDARD_DESCRIPTION_SCHEME.

5. The method of claim 1, wherein the MPEG-21_INTERFACE comprises:
a DIEL_IDENTIFIER for judging on what multimedia contents information is presently being described and identifying position of multimedia contents;
an IPMP for describing information on intellectual property management and protection of multimedia contents;
a HANDLING_USAGE for describing information on production, process, search, access, storage, delivery, and use of multimedia contents;
a DELEVERY_INTERFACE for describing information on a protocol and an interface relating to a network and a terminal through which multimedia contents are transmitted;
an EVENT_REPORTING for describing information on an ex-post facto report regarding production, transmission, or use of multimedia contents.

6. The method of claim 1, wherein the DESCRIPTION_MANAGEMENT includes an ADMINISTRATION_DATA for providing information on operation and management regarding production, modification, access and use of metadata of multimedia contents.

7. The method of claim 6, wherein the ADMINISTRATION_DATA includes management information such as version information of metadata, identifier of metadata, date of production, date of modification, manager, produced contents and reason of production.

8. The method of claim 1, wherein the DESCRIPTION_MANAGEMENT further includes a USER_DESCRIPTION for providing information on various users including a contents producer, a supplier, a distributor, a right holder and a final consumer existing in an electronic commerce business model.

9. The method of claim 8, wherein the USER_DESCRIPTION describes information including a user identifier, user's role relating multimedia contents, a name and an address of the user.

10. The method of claim 1, wherein the DESCRIPTION_MANAGEMENT includes an ACCESS_CONTROL for controlling a user access to metadata about multimedia contents so that only an authorized user can access to it.

11. The method of claim 10, wherein in the ACCESS_CONTROL describes elements such as elements subject to the access control, an identification of an authorized user, an access control policy such as an access range and an access allowance period.

12. The method of 1, wherein the DESCRIPTION_MANAGEMENT further includes a PRIVACY_CONTROL for providing a privacy control mechanism which delivers predetermined privacy protection policy to a user such that each user judges and describes metadata of the multimedia contents based on the policy.
